(19) United States
(12) Patent Application Publication
(10) Pub. No.: US 2026/0176952 A1
(43) Pub. Date: Jun. 25, 2026

(54) METHOD FOR THE ESTIMATION OF ROCK MECHANICAL PROPERTIES USING DOWNHOLE MEASUREMENTS OF BOREHOLE OVALITY

(71) Applicant: SAUDI ARABIAN OIL COMPANY, Dhahran (SA)

(72) Inventors: Denis Sabitov, Moscow (RU); Hussain AlBahrani, Qatif (SA); Marwan Charara, Moscow (RU)

(73) Assignees: Aramco Innovations LLC, Moscow (RU); SAUDI ARABIAN OIL COMPANY, Dhahran (SA)

(21) Appl. No.: 18/713,923

(22) PCT Filed: Aug. 29, 2023
(86) PCT No.: PCT/RU2023/000260

§ 371 Date: May 28, 2024

(51) Int. Cl. E21B 44/00; E21B 47/002; E21B 47/06; E21B 47/08; E21B 49/00; G01B 5/12; G01V 1/50; G01V 3/20

(52) U.S. Cl. CPC E21B 44/00; E21B 47/0025; E21B 47/06; E21B 47/08; E21B 49/00; G01B 5/12; G01V 1/50; G01V 3/20; G01V 2210/74

(57) ABSTRACT

A method for determining rock mechanical properties is disclosed. The method includes obtaining, at a selected depth location of a borehole, initial radial geometry measurements of the borehole and initial borehole fluid pressure measurements of a borehole fluid, perturbing a pressure of the borehole fluid, obtaining, in response to perturbing the pressure of the borehole fluid and at the selected depth location, dynamic radial geometry measurements of the borehole, analyzing a difference of the initial radial geometry measurements and the dynamic radial geometry measurements to determine differences in radial and axial components of strain tensor at a surface of the borehole at the selected depth location, determining the rock mechanical properties at the selected depth location by analyzing the differences in the radial and axial components of the strain tensor, and facilitating, based at least on the determined rock mechanical properties, a drilling operation of the subterranean formation.

### BACKGROUND

Mechanical rock properties are important for the safety operations in drilling process, as well as in utilizing the completed well, and makes a crucial part in the prediction of wellbore stability and planning of drilling operations. Traditional approaches of measuring the mechanical rock properties are based either on extraction of core plugs from the specific location along the borehole for laboratory experiments, performing geophysical borehole data acquisition using wireline sonic tools to determine dynamic material properties by analyzing the sonic wave tracks, or performing experiments directly in the borehole with complex devices to vary the pressure at an isolated specific segment of the borehole.

### SUMMARY

In general, in one aspect, the invention relates to a method for determining rock mechanical properties of a subterranean formation. The method includes obtaining, at a selected depth location of a borehole penetrating the subterranean formation, initial radial geometry measurements of the borehole and initial borehole fluid pressure measurements of a borehole fluid, perturbing a pressure of the borehole fluid, obtaining, in response to perturbing the pressure of the borehole fluid and at the selected depth location of the borehole, dynamic radial geometry measurements of the borehole and dynamic borehole fluid pressure measurements of the borehole fluid, analyzing a difference of the initial radial geometry measurements and the dynamic radial geometry measurements to determine differences in radial and axial components of strain tensor at a surface of the borehole at the selected depth location, determining the rock mechanical properties at the selected depth location by analyzing the differences in the radial and axial components of the strain tensor, and facilitating, based at least on the determined rock mechanical properties, a drilling operation of the subterranean formation.

In general, in one aspect, the invention relates to a system for determining rock mechanical properties of a subterranean formation. The system includes a computer processor and memory storing instructions, when executed by the computer processor, comprising functionality for obtaining, at a selected depth location of a borehole penetrating the subterranean formation, initial radial geometry measurements of the borehole and initial borehole fluid pressure measurements of a borehole fluid, perturbing a pressure of the borehole fluid, obtaining, in response to perturbing the pressure of the borehole fluid and at the selected depth location of the borehole, dynamic radial geometry measurements of the borehole and dynamic borehole fluid pressure measurements of the borehole fluid, analyzing a difference of the initial radial geometry measurements and the dynamic radial geometry measurements to determine differences in radial and axial components of strain tensor at a surface of the borehole at the selected depth location, determining the rock mechanical properties at the selected depth location by analyzing the differences in the radial and axial components of the strain tensor, and facilitating, based at least on the determined rock mechanical properties, a drilling operation of the subterranean formation.

In general, in one aspect, the invention relates to a well system for performing a drilling operation of a subterranean formation. The well system includes a bottom hole assembly (BHA) coupled to a drill string that is suspended in a borehole penetrating the subterranean formation and a rock property analysis system coupled to the BHA and comprising functionality for obtaining, at a selected depth location of the borehole, initial radial geometry measurements of the borehole and initial borehole fluid pressure measurements of a borehole fluid, perturbing a pressure of the borehole fluid, obtaining, in response to perturbing the pressure of the borehole fluid and at the selected depth location of the borehole, dynamic radial geometry measurements of the borehole and dynamic borehole fluid pressure measurements of the borehole fluid, analyzing a difference of the initial radial geometry measurements and the dynamic radial geometry measurements to determine differences in radial and axial components of strain tensor at a surface of the borehole at the selected depth location, determining rock mechanical properties at the selected depth location by analyzing the differences in the radial and axial components of the strain tensor, and performing, using the BHA and based at least on the determined rock mechanical properties, a drilling operation of the subterranean formation.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A, 1B, and 1C show systems in accordance with one or more embodiments.

FIG. 2 shows a flowchart in accordance with one or more embodiments.

FIGS. 3A-3L show examples in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of this disclosure provide a method and system for determining the mechanical parameters of the rock at a selected location within a borehole. The method includes measuring the elastic (reversible) deformation of the borehole boundary at a selected location under static pressure of the mud, re-initiating the mud circulation (or the dynamic conditions) using the rig mud pumps, and measuring the deformation of the borehole boundary under perturbed or dynamic mud pressure. Throughout this disclosure, the term “perturb” means “disrupt” or “change”. The mechanical parameters of the rock such as Young's elastic modulus and Poisson's ratio are then determined using the measurements of the deformations with static and perturbed mud pressure of the surface logging station. Accordingly, the mechanical parameters are presented to a user to facilitate the drilling operation.

Embodiments disclosed herein allow for direct measurement of mechanical properties at a specific borehole location, using caliper measurements or image logging data provided with the static and perturbed borehole mud pressure, which is done from the surface.

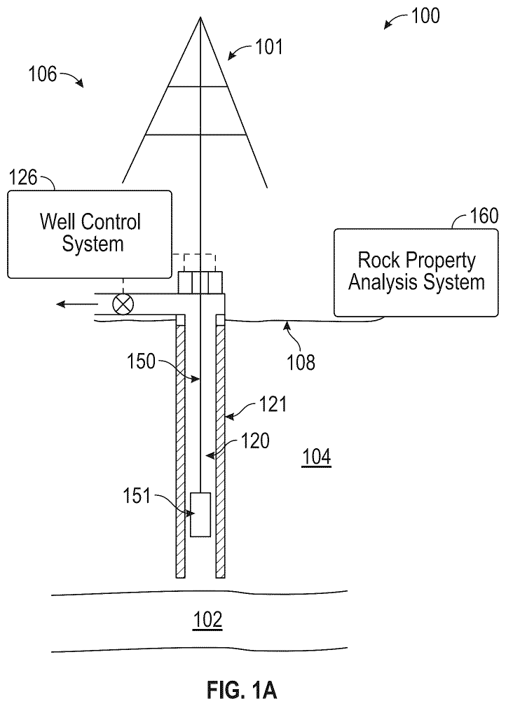

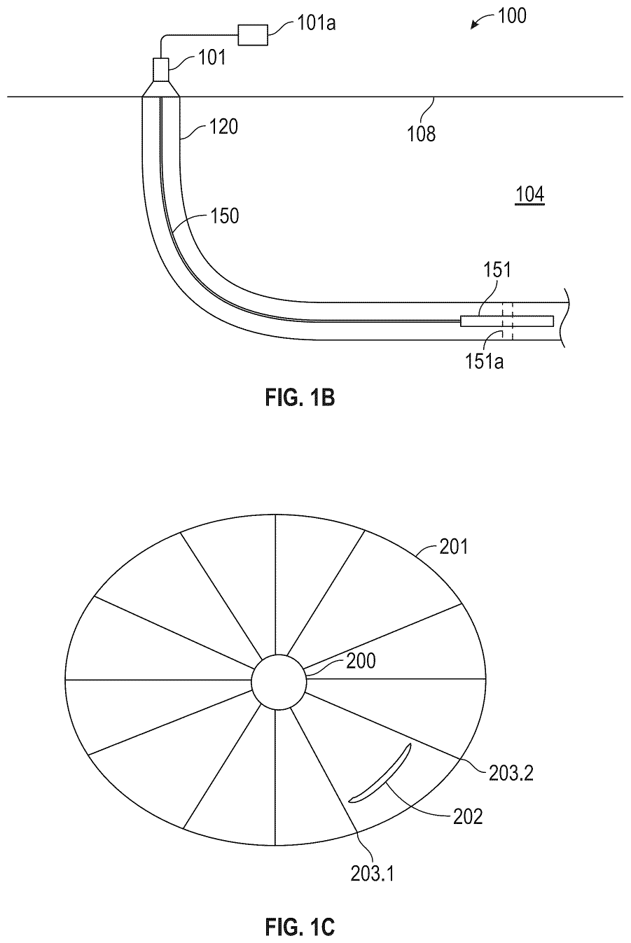

FIG. 1A shows a schematic diagram in accordance with one or more embodiments. As shown in FIG. 1A, a well environment (100) includes a subterranean formation (“formation”) (104) and a well system (106). The formation (104) may include a porous or fractured rock formation that resides underground, beneath the earth's surface (“surface”) (108). The formation (104) may include different layers of rock having varying characteristics, such as varying degrees of permeability, porosity, capillary pressure, and resistivity. In the case of the well system (106) being a hydrocarbon well, the formation (104) may include a hydrocarbon-bearing reservoir (102). In the case of the well system (106) being operated as a production well, the well system (106) may facilitate the extraction of hydrocarbons (or “production”) from the reservoir (102).

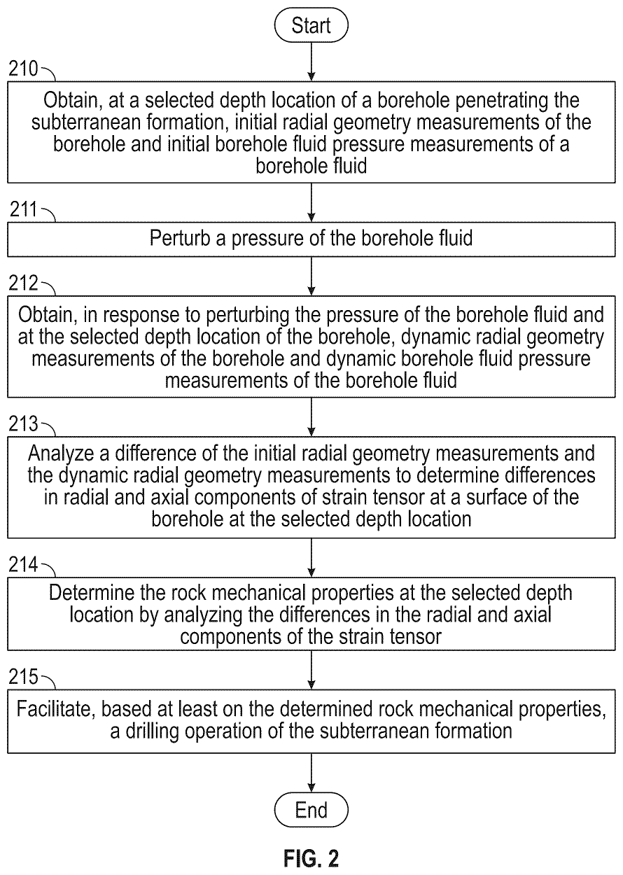

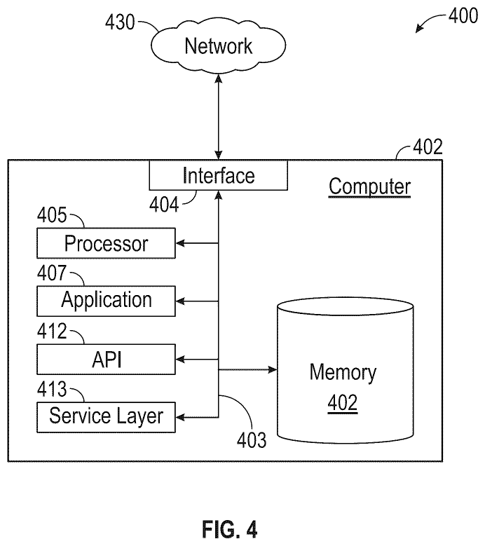

In some embodiments disclosed herein, the well system (106) includes a rig (101), a wellbore (120) with a casing (121), a rock property analysis system (160), and a well control system (126). In some embodiments, the wellbore (120) may be an uncased borehole without the casing (121). Throughout this disclosure, the wellbore (120) may also be referred to as the borehole (120), with or without the casing (121). The rock property analysis system (160) determines rock mechanical properties surrounding the wellbore (120) based on radial geometry measurements and borehole fluid pressure measurements in the borehole (120). In one or more embodiments, the rock property analysis system (160) performs these functionalities using the method described in reference to FIG. 2 below. The well control system (126) may control various operations of the well system (106), such as well production operations, well drilling operation, well completion operations, well maintenance operations, and reservoir monitoring, assessment and development operations. In one or more embodiments, the well control system (126) performs these functionalities based on the rock mechanical properties determined using the rock property analysis system (160). In some embodiments, the rock property analysis system (160) and the well control system (126) include a computer system, such as a portion of the computing system described in reference to FIG. 4 below.

The rig (101) is the machine used to drill a borehole to form the wellbore (120). Major components of the rig (101) include the drilling fluid tanks, the drilling fluid pumps (e.g., rig mixing pumps), the derrick or mast, the draw works, the rotary table or top drive, the drill string, the power generation equipment and auxiliary equipment. Drilling fluid, also referred to as “drilling mud” or simply “mud,” is used to facilitate drilling boreholes into the earth, such as drilling oil and natural gas wells. The main functions of drilling fluids include providing hydrostatic pressure to prevent formation fluids from entering into the borehole, keeping the drill bit cool and clean during drilling, carrying out drill cuttings, and suspending the drill cuttings while drilling is paused and when the drilling assembly is brought in and out of the borehole.

The wellbore (120) includes a bored hole (i.e., borehole) that extends from the surface (108) towards a target zone of the formation (104), such as the reservoir (102). An upper end of the wellbore (120), terminating at or near the surface (108), may be referred to as the “up-hole” end of the wellbore (120), and a lower end of the wellbore, terminating in the formation (104), may be referred to as the “downhole” end of the wellbore (120). The wellbore (120) may facilitate the circulation of drilling fluids during drilling operations for the wellbore (120) to extend towards the target zone of the formation (104) (e.g., the reservoir (102)), facilitate the flow of hydrocarbon production (e.g., oil and gas) from the reservoir (102) to the surface (108) during production operations, facilitate the injection of substances (e.g., water) into the hydrocarbon-bearing formation (104) or the reservoir (102) during injection operations, or facilitate the communication of monitoring devices (e.g., logging tools) lowered into the formation (104) or the reservoir (102) during monitoring operations (e.g., during in situ logging operations).

In some embodiments, the well system (106) is provided with a bottom hole assembly (BHA) (151) attached to the drill string (150) to suspend into the wellbore (120) for performing the well drilling operation. The bottom hole assembly (BHA) is the lowest part of a drill string and includes the drill bit, drill collar, stabilizer, mud motor, etc.

FIG. 1B illustrates a downhole measurement process to determine the mechanical properties of the rock of the formation (104) depicted in FIG. 1A above. In one or more embodiments, one or more of the modules and/or elements shown in FIG. 1B may be omitted, repeated, combined and/or substituted. Accordingly, embodiments disclosed herein should not be considered limited to the specific arrangements of modules and/or elements shown in FIG. 1B.

As shown in FIG. 1B, the downhole assembly (151) includes a caliper device (151a). The radial geometry measurements are provided by the caliper device (151a) which is immersed at the specific location within the fluid-filled borehole (120) and connected mechanically to the surface (108) by a drill string or a wireline (150). A mud pulse device (101a) is connected hydraulically to the borehole (120) via the rig (101) and generates the additional pressure to the borehole fluid. The caliper device (151a) measures the radial displacements of the borehole wall under static fluid pressure and under perturbed fluid pressure.

Turning to FIG. 1C, FIG. 1C illustrates the cross section of the borehole (120) with the caliper device (151a) installed in the specific location of the wellbore (120) depicted in FIG. 1B above. In one or more embodiments, one or more of the modules and/or elements shown in FIG. 1C may be omitted, repeated, combined and/or substituted. Accordingly, embodiments disclosed herein should not be considered limited to the specific arrangements of modules and/or elements shown in FIG. 1C.

The process of caliper measurements of the radial displacements of the borehole wall (201) is provided by means of circumferentially spaced measuring elements of the caliper device (200). The radial distance from the central device (200) to the borehole wall (201) is measured in several locations, e.g., (203.1) and (203.2) along respective azimuthal directions. The angle (202) between two adjacent measurement locations, or azimuthal directions, is pre-determined or otherwise known. The term “ovality” refers to a measure of deviation from a circular shape, such as a difference between radial distances measured in different azimuthal directions, e.g., (203.1) and (203.2).

In order to determine the difference of radial components of the strain tensor dεᵣᵣ on the boundary of the well (201), at least two radial caliper measurements

$${u}_{r}^{1} and {u}_{r}^{2}$$

for different fluid pressures are sued to substitute into the following formula Eq. (1).

$$d {ε}_{rr} = \frac{{u}_{r}^{2} - {u}_{r}^{1}}{{u}_{r}^{1}} \qquad Eq . ( 1 )$$

The differences of axial components of the strain tensor dε_{φφ} on the boundary of the wall (201) are obtained in three steps. First, the law of cosines Eq. (2) is used to determine the distance between two neighboring points at the borehole wall (201) with static fluid pressure.

$${u}_{φ}^{1} = \sqrt{{[ {u}_{r}^{( 203.1 )} ]}^{2} + {[ {u}_{r}^{( 203.2 )} ]}^{2} - 2 {u}_{r}^{( 203.1 )} {u}_{r}^{( 203.2 )} cos ( {α}^{( 202 )} )} \qquad Eq . ( 2 )$$

Second, the same procedure is implemented to determine the distance

$${u}_{φ}^{2}$$

between two neighboring points at the borehole wall (201) with perturbed fluid pressure, using the radial measurements from the step with perturbed fluid pressure. Third, the difference in axial components of stress tensor is determined by the following formula Eq. (3).

$$d {ε}_{ϕϕ} = \frac{{u}_{φ}^{2} - {u}_{φ}^{1}}{{u}_{φ}^{1}} \qquad Eq . ( 3 )$$

The mechanical properties of the rock, specifically the Young's elastic modulus E and Poisson's ratio ν, are determined using the solution of 3D elastic stress state near the borehole and the Hooke's relation between stresses and strains for isotropic material. Using the Lamè coefficients, three equations Eq. (4), Eq. (5), and Eq. (6) describing the balance of forces on the borehole wall for the perturbed fluid pressure dp are as below.

$$( λ + 2 μ ) d {ε}_{φφ} + λ ( d {ε}_{rr} + d {ε}_{zz} ) = d {σ}_{φφ} = - dp \qquad Eq . ( 4 )$$

$$( λ + 2 μ ) d {ε}_{rr} + λ ( d {ε}_{φφ} + d {ε}_{zz} ) = d {σ}_{rr} = dp \qquad Eq . ( 5 )$$

$$( λ + 2 μ ) d {ε}_{zz} + λ ( d {ε}_{φφ} + d {ε}_{rr} ) = d {σ}_{zz} = 0 \qquad Eq . ( 6 )$$

This system of linear equations contains three measurable components: dεᵣᵣ, dε_{φφ}, and dp, and three unknowns: Lamè coefficients λ and μ, and dε_{zz}. Solving this system for three unknowns, the Lamè coefficients are obtained. Next, the values of Young's elastic modulus and Poisson's ratio are determined using the standard formulas Eq. (7) and Eq. (8).

$$E = \frac{μ ( 3 λ + 2 μ )}{λ + μ} \qquad Eq . ( 7 )$$

$$v = \frac{λ}{2 ( λ + μ )} \qquad Eq . ( 8 )$$

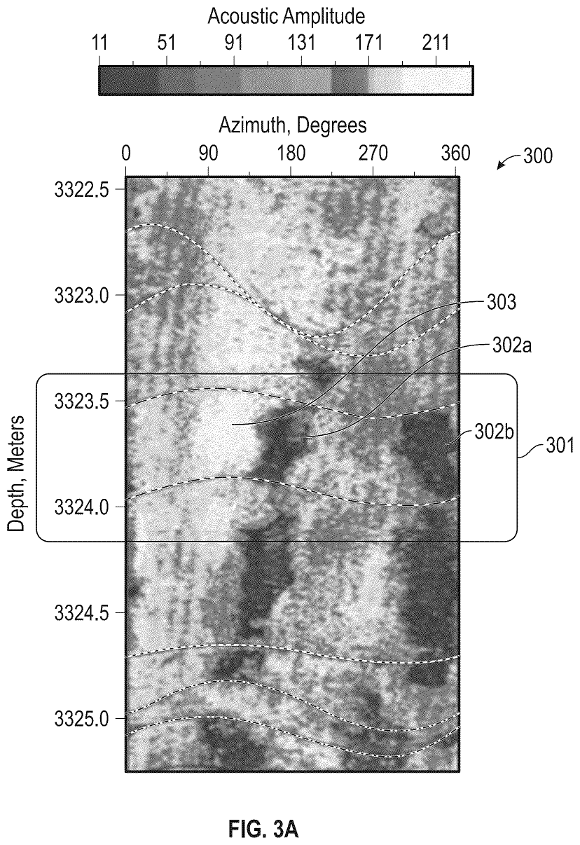

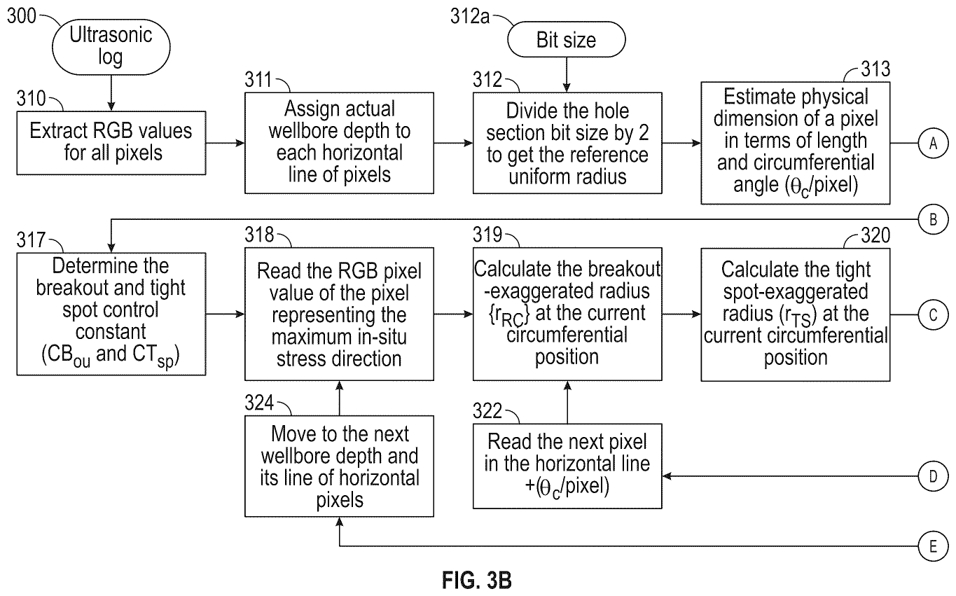

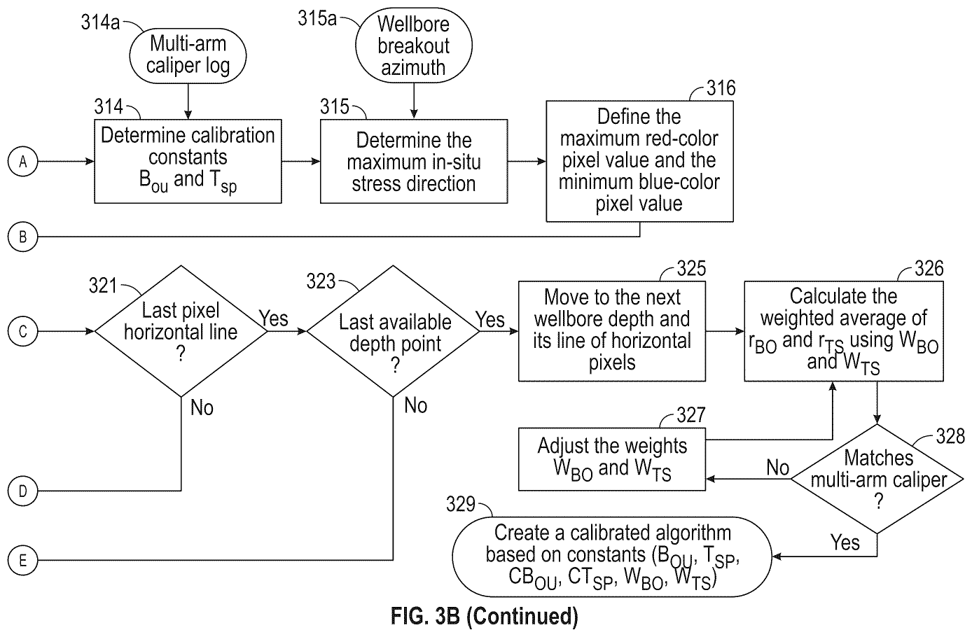

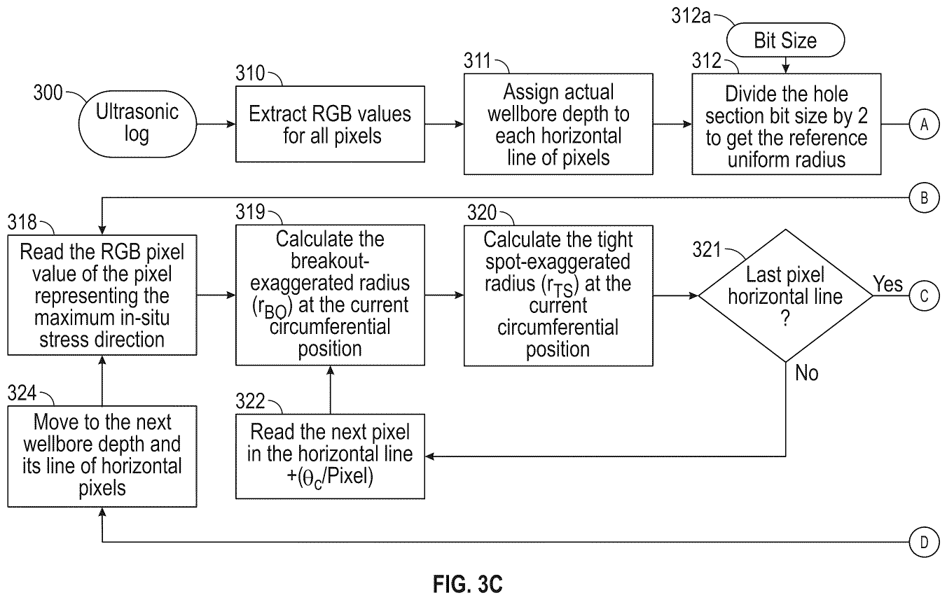

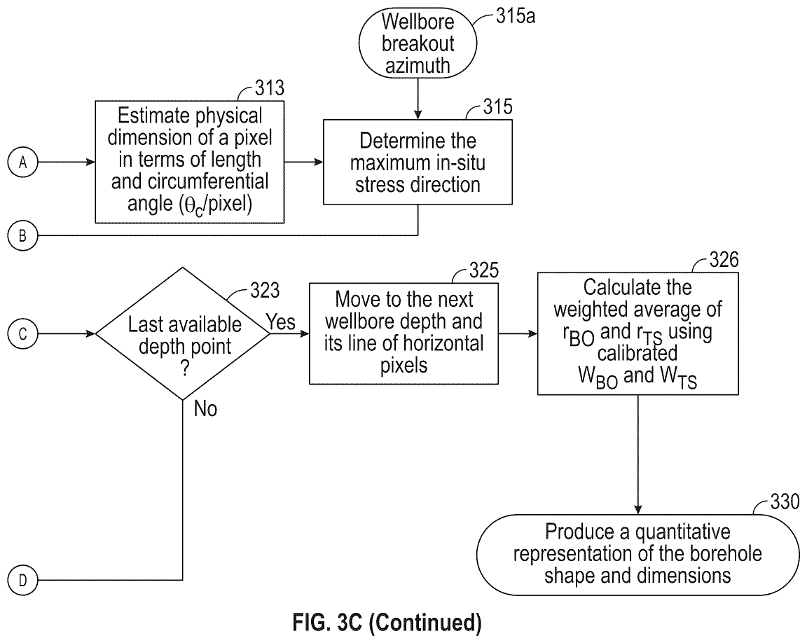

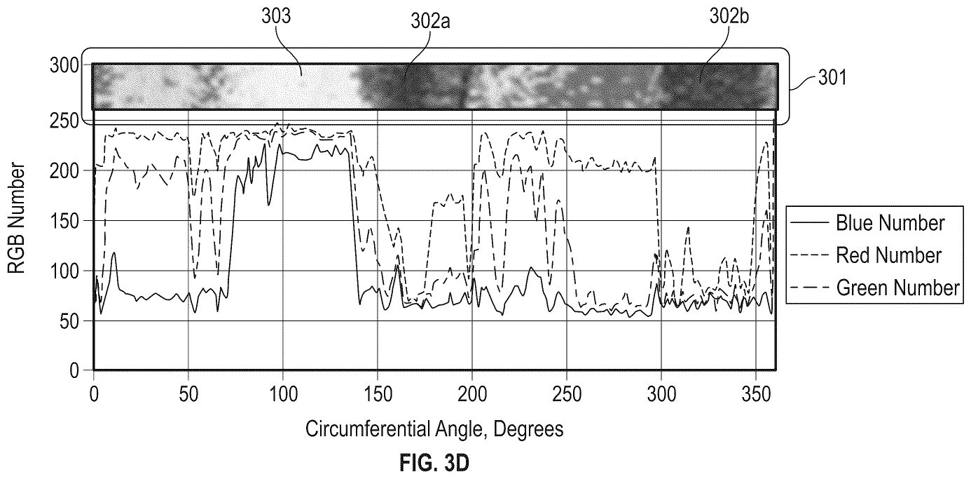

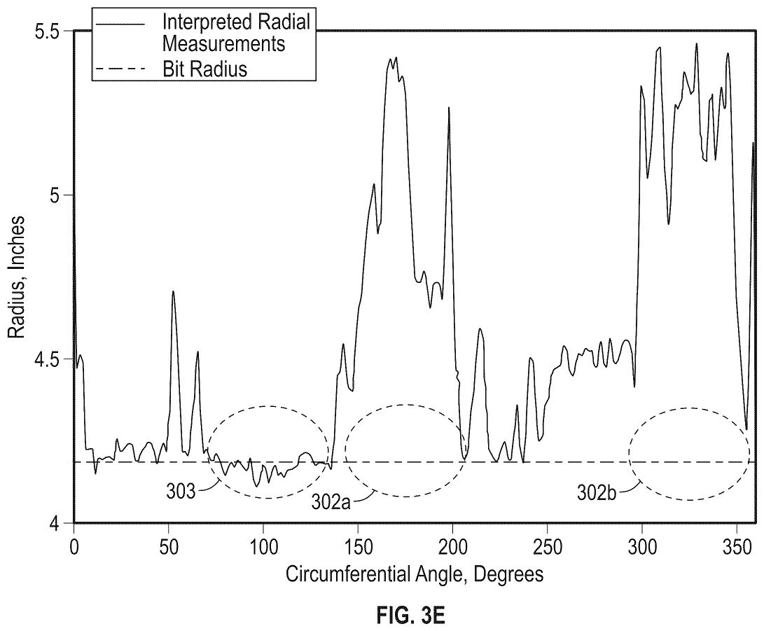

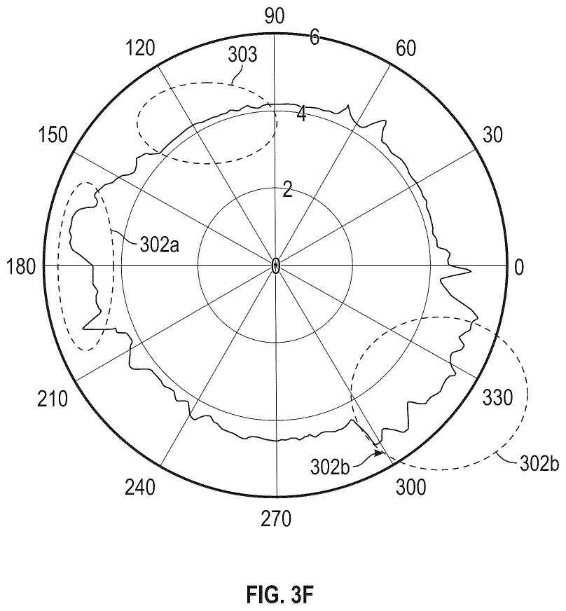

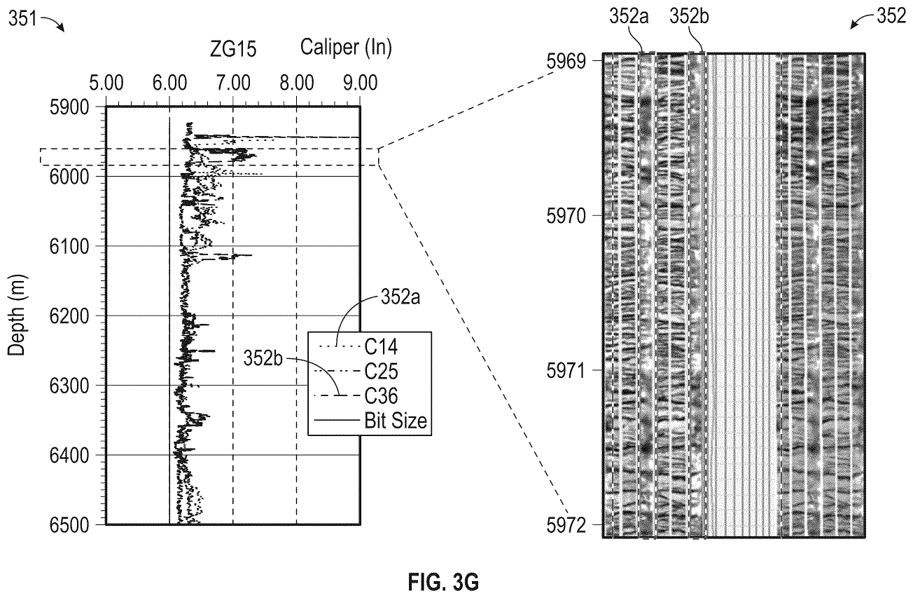

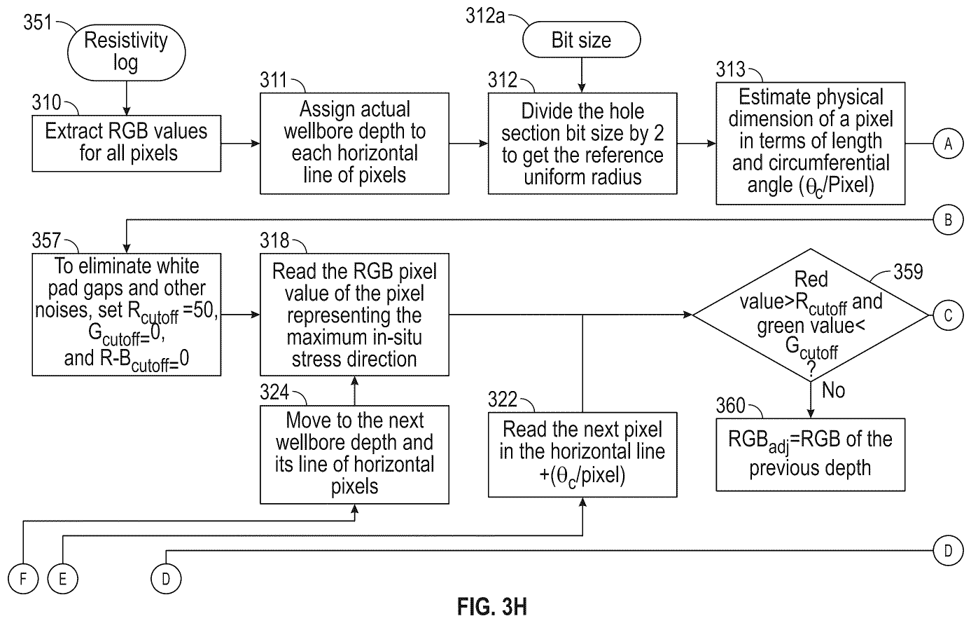

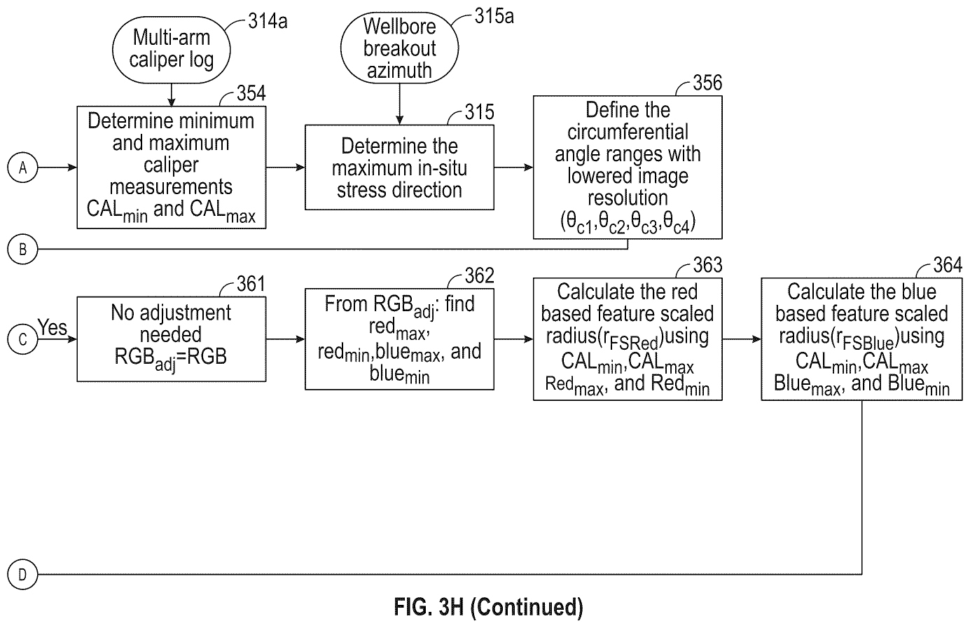

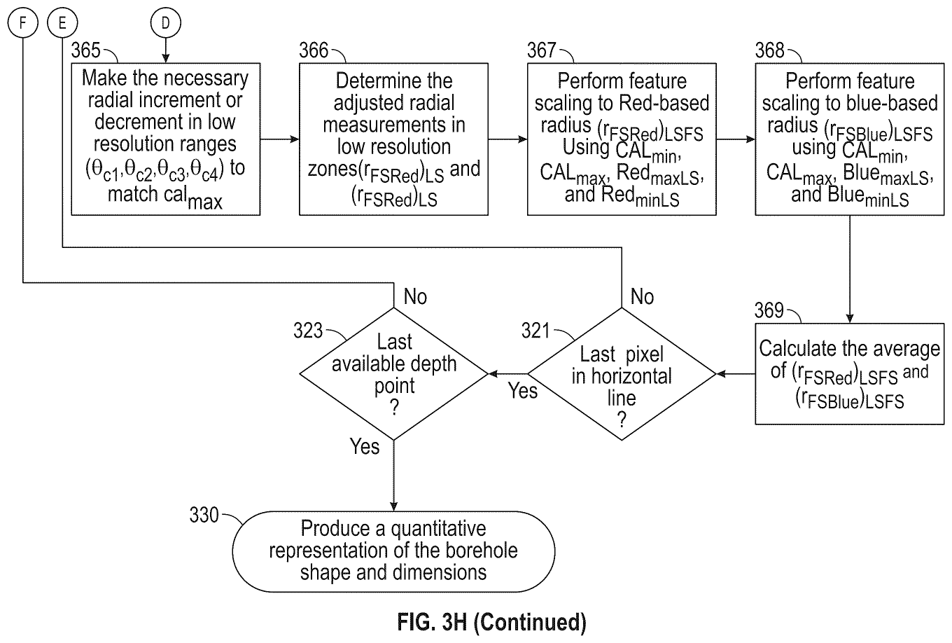

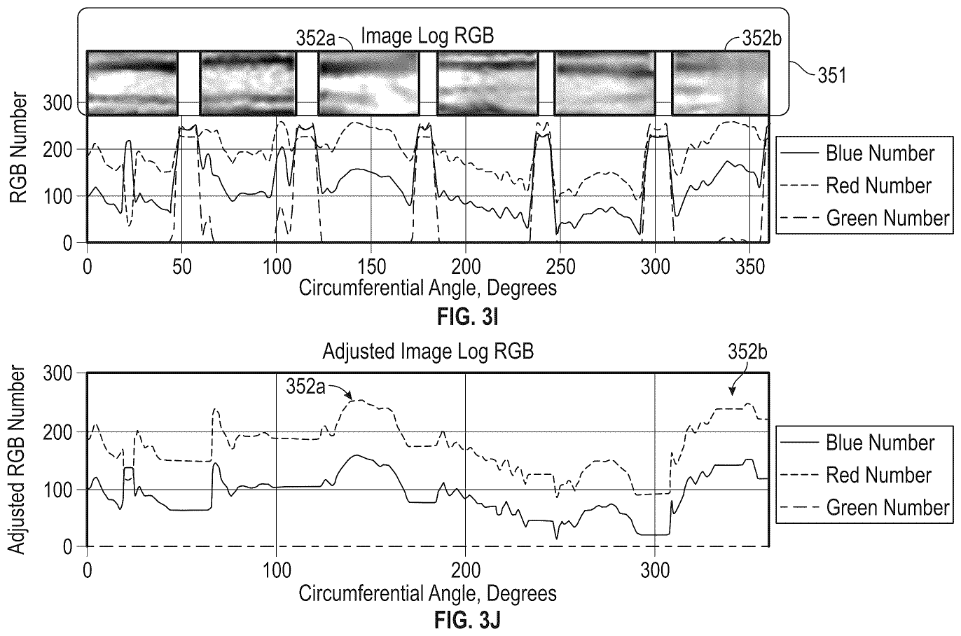

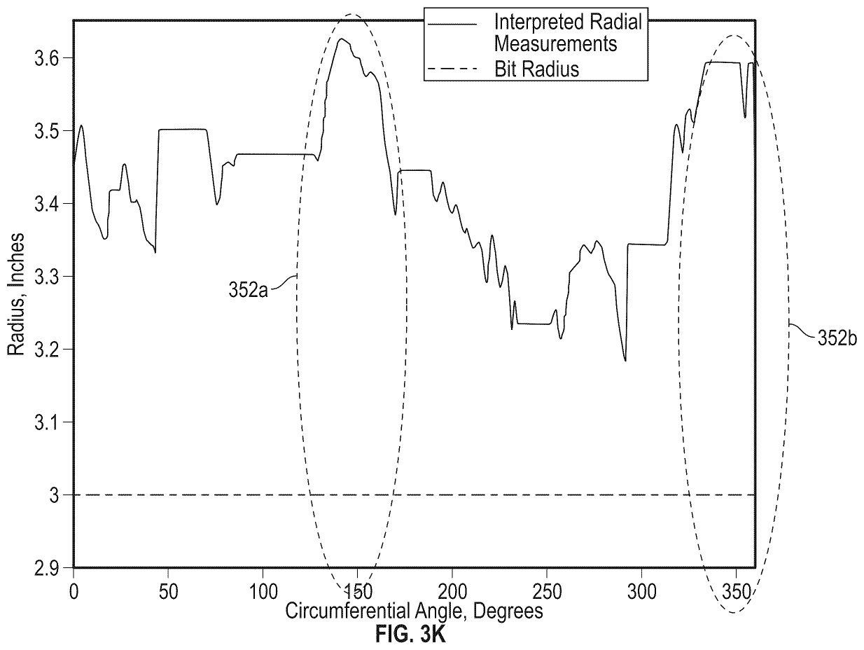

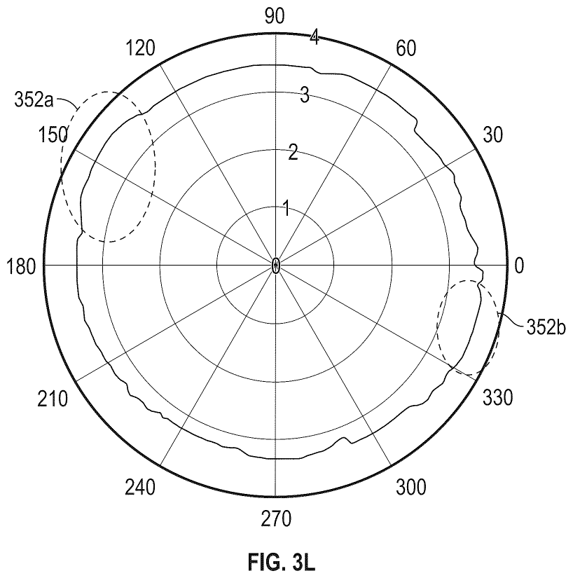

Alternatively, the same radial measurements can also be provided through what is known as image logs. These are images that can be acquired from a logging-while-drilling (LWD) tool during both static conditions and perturbed/dynamic conditions. These image logs give a full description of the wellbore geometry at both conditions. The images are either resistivity based or ultrasonic based. In both types, these images required a specialized algorithm so that the desired radial measurements are extracted. Example algorithms that can be used to extract the radial measurements from each image type are described in reference to FIGS. 3A-3L below.

Turning to FIG. 2, FIG. 2 shows a process flowchart in accordance with one or more embodiments. Specifically, FIG. 2 describes a method for determining the mechanical parameters of the rock at a selected location within a borehole. One or more blocks in FIG. 2 may be performed using one or more components as described in FIGS. 1A-1C. While the various blocks in FIG. 2 are presented and described sequentially, one of ordinary skill in the art will appreciate that some or all of the blocks may be executed in a different order, may be combined or omitted, and some or all of the blocks may be executed in parallel and/or iteratively. Furthermore, the blocks may be performed actively or passively.

Initially in Block 210, radial geometry measurements of the borehole are obtained at a selected depth location. In addition, the pressure of the borehole fluid is measured at the same depth location. The radial geometry measurements and the pressure measurements of the borehole fluid are referred to as initial measurements. In one or more embodiments, the initial radial geometry measurements and the initial pressure measurements of the borehole fluid are measured without any drilling fluid (i.e., mud) circulation (referred to as the static condition) and are referred to as static radial geometry measurements and static borehole fluid pressure measurements. In one or more embodiments, the radial geometry measurements include a measurement of the radial displacements of the borehole wall along each of a number of pre-determined azimuthal directions within the borehole. In one or more embodiments, the radial displacements of the borehole wall are determined using a mechanical caliper device. In such embodiments, the radial geometry measurements include a measurement of the radial displacements of the borehole wall along each of a number of pre-determined azimuthal directions within the borehole where mechanical caliper measuring elements are disposed along a circumference of the mechanical caliper device.

In one or more embodiments, the radial displacements of the borehole wall are determined by analyzing an image log of the borehole that is obtained using a LWD downhole tool. In such embodiments, an image log interpretation algorithm is calibrated based on the radial geometry measurements obtained using the mechanical caliper device before being used to analyze the image log. The image log may include an ultrasonic image log that is analyzed using an ultrasonic image log interpretation algorithm or a resistivity image log that is analyzed using a resistivity image log interpretation algorithm. The radial geometry measurements obtained using the mechanical caliper device or obtained by analyzing image logs using calibrated image log interpretation algorithms are referred to as caliper measurements.

In Block 211, the pressure of the borehole fluid at the selected depth location is perturbed by re-initiating mud circulation through the rig mud pumps. In other words, the pressure of the borehole fluid is perturbed by generating an additional fluid pressure from the surface and is referred to as a dynamic borehole fluid pressure.

In Block 212, the perturbed or dynamic radial geometry measurements of the borehole are obtained at the selected depth location during the mud circulation (referred to as the dynamic condition). In addition, the measurement of the perturbed or dynamic fluid pressure at the same depth location is also obtained. The dynamic radial geometry measurements are affected by the additional pressure of the borehole fluid due to the mud circulation driven by the rig mud pump.

In Block 213, the differences of the radial geometry measurements between the static condition and the dynamic condition are calculated and analyzed to determine the differences in radial and axial components of strain tensor at the borehole surface of the selected depth location.

The differences in measurements between the static condition and the dynamic condition are due to the change to the effective bottom hole pressure. During circulation (i.e. dynamic or perturbed conditions), the annular pressure frictional losses (APL) increase the effective bottom hole pressure. In these conditions, the bottom hole pressure consists of the drilling fluid hydrostatic pressure and the APL. This effective bottom hole pressure is also known as the effective circulation density (ECD). Another reason for the differences in measurements between the static condition and the dynamic condition is a phenomenon known as wellbore ballooning.

In Block 214, the mechanical properties of the formation rock at the selected depth location are determined by analyzing the values of differences in radial and axial strain components obtained in Block 213 above. In one or more embodiments, the mechanical properties of the formation rock in the selected depth location within the borehole is determined by solving the system of linear equations describing the equilibrium od forces on the borehole wall.

Blocks 210 through 214 described above may be performed either during time intervals between drilling stages using Logging While Drilling (LWD) caliper measurements of the radial geometry, or as a separate service utilizing wireline caliper measurements of the radial geometry.

In Block 215, the mechanical properties of the formation rock are presented to a user to facilitate the drilling operation. In one or more embodiments, the drilling parameters (e.g., rotational speed, weight-on-bit, rate of penetration, etc.) are adjusted based on the mechanical properties of the formation rock to optimize, or otherwise improve, the drilling operation. For example, the drilling parameters may be adjusted to minimize, or otherwise reduce, the effect of rapid frictional-temperature changes to control damages to the downhole tool and minimize hole-size calculation errors. In other words, the concurrent drilling and sensing operations described above enhance the effectiveness of the drilling operation. The environmental parameter measurement (e.g., mechanical properties of the formation rock) and corresponding analysis result (e.g., of differences in radial and axial strain components) that are generated while drilling may also contribute to accurate reservoir modelling to improve (i) the design of future drilling operations on the same field and reservoir to increase hydrocarbon production, (ii) the exploration of hydrocarbon resources that are difficult to recover due to challenging environments such as deep-water wells, and (iii) the ultimate recovery factor from existing fields.

FIGS. 3A-3F show an example in accordance with one or more embodiments. The example shown in FIGS. 3A-3F are based on the system and method described in reference to FIGS. 1A-IC and 2 above. In particular, FIGS. 3A-3F show an example of determining the mechanical parameters of the rock using an algorithm for field-based ultrasonic log imaging for borehole radial measurements. In one or more embodiments, one or more of the modules and/or elements shown in FIGS. 3A-3F may be omitted, repeated, combined and/or substituted. Accordingly, embodiments disclosed herein should not be considered limited to the specific arrangements of modules and/or elements shown in FIGS. 3A-3F.

The algorithm converts a specific type of image logs, which is ultrasonic based, into caliper readings that cover the 360° of the wellbore circumference. Instead of relying on conventional mechanical caliper logs, which provide radial measurements at only four circumferential angles (0°, 90°, 180°, 270°) in common mechanical caliper designs, it is now possible to rely on images to produce radial measurements at all circumferential angles. The resolution of radial measurements is dependent on the image log resolution.

The ultrasonic image logs are the preferred form of image logs for this type of application. This is due to two main reasons. First, unlike the resistivity image logs, ultrasonic image logs have no gaps, and therefore, can provide a full and comprehensive description of the wellbore state. Second, they are available in logging while drilling (LWD) tools in the form of density-based images, which means they can be used in a real-time setting or a while-drilling setting to feed new information into numerical models.

The main difference in the interpretation process between lab-based images (e.g., CT-scans) and field-based image logs is that field-based image logs cannot be solely relied on to produce the interpretation. This is mainly due to the challenging environment in which these images are obtained. This is also due to variations in image attributes from one commercial logging tool to the other. This means that field image logs require more support information and validation than lab-based images. The support information used in this application is mechanical caliper log readings. For each image logging tool, the analysis of its images can be calibrated and validated against mechanical caliper measurements taken from the same interval where the images are produced. This ensures that the quantitative assessment of enlargements and tight spots from an image is validated using the mechanical caliper measurements of the same enlargements and tight spots. Once this process is performed, the calibrated algorithm can be used to interpret images from the same logging tool with more confidence without the need to run a mechanical caliper log every time an image log is produced.

This process is used for interpreting ultrasonic image logs by converting the RGB color number or values of each pixel to radial measurements. FIG. 3A shows an example of an ultrasonic image log from an 8.375″ diameter wellbore showing stress-induced wellbore enlargements. RGB values are represented in FIG. 3A using the gray scale for example purposes. The area (301) is the interval that is used to provide an example of an image log interpretation.

FIG. 3B shows a flowchart that describes the algorithm of calibrating an ultrasonic image log interpretation using multi-arm caliper measurements. As shown in FIG. 3B, this algorithm relies on additional data other than the image log (300) itself to perform the calibration process. In Block 310, RGB values for all pixels in the ultrasonic log (300) are extracted. The red, green, and blue (RGB) values refer to the numerical values assigned to each pixel in the ultrasonic image based on the RGB color model. Because the color variations in each pixel can be represented by the RGB numerical values, these are extracted from the image. This method converts an image into an array of numerical values, which can then be used in the following steps of the algorithm The additional data includes the bit size (312a), multi-arm mechanical caliper log measurements (314a), and a definition of the direction of the maximum in-situ stress (i.e., wellbore breakout azimuth (315a)). The bit size (312a) is used to assign a physical dimension to an individual pixel size. In Block 311, actual wellbore depth is assigned to each horizontal line of pixels in the ultrasonic log (300). In Block 312, the hole section bit size (312a) is divided by 2 to determine the reference uniform radius. In Block 313, the physical dimension of a pixel is estimated in terms of length and circumferential angle, i.e., polar coordinates. In Block 315, the maximum in-situ stress direction (i.e., wellbore breakout azimuth (315a)) is determined so that it can be correlated with the direction of wellbore enlargements or the wellbore breakout azimuth (315) as observed in the ultrasonic image log (300). In Block 316, the maximum red-color pixel value and the minimum blue-color pixel value are defined. The maximum red color pixel is the pixel within the image that has the highest red color value based its RGB numerical values. The minimum blue color pixel is the pixel within the image that has the lowest red color value based on its RGB numerical values. These are identified by comparing the RGB values of all pixels, which were collectively extracted in block 310. The maximum red color represents the brightest or lightest pixel (in terms of coloring) within the image, which indicates the smallest well radius detected in the image. The minimum blue color pixel represents the darkest pixel (in terms of coloring) within the image, which indicates the largest well radius detected in the image. The multi-arm mechanical caliper log measurements are used in Block 328 to ascertain the extent of the radial depth of a dark-colored breakout zone such as the breakout zones (302a, 302b) shown in FIG. 3A. They are also used to ensure correct interpretation of tight spots, which are characterized by bright spots (303) on the ultrasonic image log (300), such as the bright spot (303) shown in FIG. 3A, and a radius that is smaller than that of the bit size. In Block 317, Bₒᵤ and Tₛₚ, which are the breakout and the tight spot calibration constants, respectively, are determined. The next step in the algorithm described in FIG. 3C is to extract the maximum red color pixel value and the minimum blue color pixel value. These two values are used to determine the breakout and tight spot control constants CBₒᵤ and CTₛₚ as below. Bₒᵤ and Tₛₚ are two constants that are determined using a matching process between the mechanical caliper data (box 314a) and the interpreted radii measurements from the image log. On the other hand, CBₒᵤ and CTₛₚ are determined from the equations below.

$$C {B}_{ou} = \frac{Bit size}{Maximum red color pixel value} \qquad Eq . ( 9 )$$

$${CT}_{sp} = \frac{Bit size}{Minimum blue color pixel value} \qquad Eq . ( 10 )$$

CBₒᵤ and CTₛₚ are correlated to the identification of the most dark colored region in the image (which represents the deepest breakout) and the most brightly colored region (which represents the tightest spot in the hole). These constants, along with the calibration constants, are used to calculate the breakout-exaggerated radii (r_{BO}) in Block 319 and calculate the tight spot exaggerated-radii (r_{TS}) in Block 320 using the formulae as below.

$${r}_{BO} = {B}_{ou} ( Bit size - ( {Red}_{i} \times {CB}_{ou} ) ) + Bit size \qquad Eq . ( 11 )$$

$${r}_{TS} = {T}_{s p} ( Bit size - ( {Blue}_{i} \times {CT}_{sp} ) ) + Bit size \qquad Eq . ( 12 )$$

In Eq. (11) and Eq. (12), Red and Blue; are the red and blue values obtained in Block 318 for all pixels in a single horizontal line which defines the borehole full circumference. The breakout-exaggerated radii (r_{BO}) and the tight spot exaggerated-radii (r_{TS}) are iteratively calculated for all horizontal lines within a depth interval (e.g., area (301) shown in FIG. 3A) according to the Blocks 321, 322, 323, 324, and 325. The final step is the Block 326 where a weighted average between (r_{BO}) and the tight spot exaggerated-radii (r_{TS}) are calculated using the formulae as below.

$$Radius = {W}_{BO} \times {r}_{BO} + {W}_{TS} \times {r}_{TS} \qquad Eq . ( 13 )$$

In Block 327, W_{BO} and W_{TS} are the average weights, which are adjusted or otherwise determined through a trial-and-error process that involves matching the weighted average with the actual multi-arm mechanical caliper log measurements in Block 328. In Block 329, the breakout-exaggerated radii (r_{BO}), the tight spot exaggerated-radii (r_{TS}), breakout calibration constant (Bₒᵤ), the tight spot calibration constant (Tₛₚ) and the average weights W_{BO} and W_{TS} are stored as calibration constants of an ultrasonic image log interpretation algorithm (referred to as the calibrated algorithm). Based on these stored calibration constants, Eq. (9) through Eq. (13) form a basis of a calibrated ultrasonic image log model.

As described above, once the calibration algorithm depicted in FIG. 3B is applied to calibrate a certain ultrasonic imaging tool that generated the ultrasonic log image (300), other image produced by this ultrasonic imaging tool in new borehole sections or new wells can be interpreted according to the calibrated ultrasonic image log model to produce full 360° radial measurements.

FIG. 3C shows a flowchart that describes the calibrated algorithm for applying the calibrated ultrasonic image log model to interpret ultrasonic log images to produce full 360° radial measurements. As shown in FIG. 3C, the flowchart for applying the calibrated ultrasonic image log model to interpret ultrasonic log images corresponds to the flowchart for calibrating the ultrasonic image log interpretation algorithm depicted in FIG. 3B where Blocks 314, 314a, 316, 317, and 327-329 that perform calibration procedures are removed. Accordingly, using the breakout-exaggerated radii (r_{BO}), the tight spot exaggerated-radii (r_{TS}), breakout calibration constant (Bₒᵤ), the tight spot calibration constant (Tₛₚ) and the average weights W_{BO} and W_{TS} as calibration constants of the calibrated ultrasonic image log interpretation algorithm, the calculation in Block 326 produces a quantitative representation of the borehole shape and dimensions (e.g., azimuth dependent radii) in Block 330.

The results of the interpretation of the ultrasonic image log (300) depicted in FIG. 3A using the algorithms depicted in FIGS. 3B-3C are shown in FIGS. 3D-3F. FIG. 3D illustrates the clear correlation between the RGB number and the locations of enlargements (i.e., breakouts 302a, 302b) and tight spots (303). This correlation is then used along with calibrating values from a mechanical multi-arm caliper log to calculate the radial measurements of the wellbore at all directions. As mentioned previously, the number of radial measurements produced is dependent on the number of pixels available in the image log (i.e., image resolution). In this particular example, the image log has a resolution of 221 pixels along the 360° degrees around the wellbore, which corresponds to approximately one radius measurement for each 1.63° degrees around the circumference of the wellbore. FIGS. 3E-3F show the final results of the image log interpretations that are calibrated with mechanical caliper log readings in both cartesian coordinate (i.e., FIG. 3E) and polar coordinate (i.e., FIG. 3F). When comparing the ultrasonic image log interval (301) in FIG. 3A to the interpreted radial measurements in FIGS. 3E-3F, it can be seen that the dark regions (302a, 302b) in the image that signify the presence of wellbore enlargements/breakouts are also reflected as radial measurements that are higher than the bit radius.

FIGS. 3G-3L show an example in accordance with one or more embodiments. The example shown in FIGS. 3G-3L are based on the system and method described in reference to FIGS. 1A-1C and 2 above. In particular, FIGS. 3G-3L show an example of determining the mechanical parameters of the rock using an algorithm for field-based resistivity log imaging for borehole radial measurements. In one or more embodiments, one or more of the modules and/or elements shown in FIGS. 3G-3L may be omitted, repeated, combined and/or substituted. Accordingly, embodiments disclosed herein should not be considered limited to the specific arrangements of modules and/or elements shown in FIGS. 3G-3L.

Similar to the ultrasonic image log algorithm described in reference to FIGS. 3B-3C above, the resistivity image log algorithm converts resistivity image logs into caliper readings that cover the 360° of the wellbore. The main difference between sonic-based images and resistivity-based images is that resistivity images normally contain several gaps due to the space between the electrical pads of the resistivity image logging tool. Resistivity based image logs also differ from sonic-based images in the way a breakout (or wellbore enlargement) can be identified. In some images, changes in color (i.e., RGB readings) are sufficient, however, in resistivity images, changes in color alone can be misleading as they can signify laminations, faults, natural, and induced fractures along with breakouts. This means that resistivity logs are efficient indicators of ‘physical features’ within the wellbore, but they are poor indicators of the spatial (e.g., radial) extension of these physical features. One distinguishing feature of breakouts in resistivity logs is the lowered resolution of the image at that breakout orientation. The lower resolution at breakouts is due to the electrical pad of the logging tool being further away from the wellbore wall when the resistivity image measurements are taken. This change in color resolution is exploited in the resistivity image interpretation algorithm to identify the orientation of breakouts. However, it's not sufficient to assess the extent of the enlargement. For this issue, multi-arm caliper readings are used to correlate the radial extent at every location in the wellbore. The pixels RGB readings are feature scaled using the following formula Eq. (14) to yield the needed radii.

$$Scaled RGB = C A {L}_{min} + ( \frac{{RGB}_{adj} - {RGB}_{min}}{{RBG}_{max} - {RGB}_{min}} ( {CAL}_{max} - {CAL}_{min} ) ) \qquad Eq . ( 14 )$$

Where CALₘᵢₙ and CALₘₐₓ are minimum and maximum multi-arm mechanical caliper radius readings respectively, which are used for calibration. RGB_{adj} is the adjusted RGB reading for filtering out noise and white gaps in the resistivity image. Using this method in interpreting resistivity image logs requires the availability of multi-arm caliper data and cannot be performed in real-time. In particular, conventional resistivity-based image logs are not available through LWD in the same manner as ultrasonic density-based images.

An example of a resistivity image log along with mechanical caliper log readings are shown in FIG. 3G. The highlighted region (351a) in the resistivity image log (351) includes low-resolution areas that indicate the presence of wellbore enlargements. The highlighted vertical areas (352a, 352b) in the mechanical caliper log (352) correspond to the azimuthal directions (352a, 352b) from which the two traces in the resistivity image log (351) is obtained. In particular, each vertical area in the mechanical caliper log (352) represents resistivity reading at a particular azimuth direction.

FIG. 3H shows the flow chart of the algorithm for interpreting resistivity-based image logs. Similar to the ultrasonic log algorithm, this algorithm relies on additional data other than the image log itself to perform the interpretations process. The additional data includes the bit size, multi-arm mechanical caliper log measurements, and a definition of the direction of the maximum in-situ stress. As shown in FIG. 3H, the flowchart for the resistivity-based image log interpretation algorithm corresponds to the flowcharts for calibrating and applying the ultrasonic image log interpretation algorithm depicted in FIGS. 3B-3C where Blocks 300, 314, 314a, 316, 317, 319, 320, and 325-329 that perform procedures specific to ultrasonic images are replaced with new Blocks 351, 354, 356, 357, and 359-369. In Block 359, the red and green values of the image pixel are compared with cut off thresholds. In Block 360, the RGB pixel values are set to the values of the previous depth if the comparison result in Block 359 is negative. In Block 361, the RGB pixel values are unchanged if the comparison result in Block 359 is positive. In Block 362, the maximum red value and the minimum blue value are determined. In Block 363, the red based feature scaled radius is calculated. In Block 364, the blue based feature scaled radius is calculated. In Block 365, radial increment or decrement are made in low resolution ranges. In Block 366, the adjusted radial measurements are determined in low resolution zones. In Block 367, feature scaling is performed to red-based radius. In Block 368, feature scaling is performed to blue-based radius. In Block 369, the average of red-based radius and blue-based radius is calculated.

In the blocks specific to the resistivity image logs, the low-resolution zones are defined using the circumferential angle ranges (θ_{c1}, θ_{c2}, θ_{c3}, θ_{c4}) where 1 and 2 define the starting and final angle of the first zone while 3 and 4 define the range for the second zone. The RGB values are adjusted to produce RGB_{adj} for the purpose of filtering out noise and white gaps in the image. This adjustment process relies of an upper cutoff value of 0 for each pixel green color value (G_{cutoff}), a lower value of 50 for each pixel red color value (R_{cutoff}), a lower value of 0 for the subtraction of blue from red color values (R-B_{cutoff}). (Inventor, please explain what each of red, green, blue colors represent in the resistivity log.) The minimum and maximum multi-arm mechanical caliper radius readings (CALₘᵢₙ and CALₘₐₓ), the circumferential angle ranges (θ_{c1}, θ_{c2}, θ_{c3}, θ_{c4}) and the color cutoff values (G_{cutoff}, R_{cutoff}, R-B_{cutoff}) are added to the breakout-exaggerated radii (r_{BO}), the tight spot exaggerated-radii (r_{TS}), breakout calibration constant (Bₒᵤ), the tight spot calibration constant (Tₛₚ) and the average weights W_{BO} and W_{TS} as calibration constants of the calibrated resistivity image log interpretation algorithm. Accordingly, the calculation in Block 369 produces a quantitative representation of the borehole shape and dimensions (e.g., azimuth dependent radii) in Block 330.

FIG. 3I shows the original RGB number of the resistivity image log (351) depicted in FIGS. 3G-3H above. FIG. 3J shows the adjusted RGB values to account for the image gaps and other image noise. FIGS. 3K-3L show the final results of the resistivity image log interpretations that are calibrated with mechanical caliper log readings in both cartesian coordinate (i.e., FIG. 3K) and polar coordinate (i.e., FIG. 3L). When comparing the resistivity image log azimuthal directions (352a, 352b) in FIG. 3G to the interpreted radial measurements in FIGS. 3K-3L, it can be clearly seen that the low-resolution regions in the image that signify the presence of wellbore enlargements are also reflected as radial measurements that are higher than the bit radius. Also, when examining the mechanical caliper readings in the highlighted interval (351a) to the left FIG. 3G, it can be clearly seen that there is an agreement that the wellbore is fully enlarged at all directions.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (Saas), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for determining rock mechanical properties of a subterranean formation, comprising:
obtaining, at a selected depth location of a borehole penetrating the subterranean formation, initial radial geometry measurements of the borehole and initial borehole fluid pressure measurements of a borehole fluid;
perturbing a pressure of the borehole fluid;
obtaining, in response to perturbing the pressure of the borehole fluid and at the selected depth location of the borehole, dynamic radial geometry measurements of the borehole and dynamic borehole fluid pressure measurements of the borehole fluid;
analyzing a difference of the initial radial geometry measurements and the dynamic radial geometry measurements to determine differences in radial and axial components of strain tensor at a surface of the borehole at the selected depth location;
determining the rock mechanical properties at the selected depth location by analyzing the differences in the radial and axial components of the strain tensor; and
facilitating, based at least on the determined rock mechanical properties, a drilling operation of the subterranean formation.

2. The method of claim 1, further comprising:
stopping, prior to obtaining the initial radial geometry measurements and the initial borehole fluid pressure measurements, wherein the initial radial geometry measurements and the initial borehole fluid pressure measurements are obtained in a static condition of the borehole; and
activating, prior to obtaining the dynamic radial geometry measurements and the dynamic borehole fluid pressure measurements, a rig mud pump to perturb the pressure of the borehole fluid, wherein the dynamic radial geometry measurements and the dynamic borehole fluid pressure measurements are obtained in a dynamic condition of the borehole.

3. The method of claim 1, further comprising:
deploying a downhole mechanical caliper device into the borehole,
wherein the initial radial geometry measurements and the dynamic radial geometry measurements are obtained using the downhole mechanical caliper device.

4. The method of claim 2, further comprising:
deploying, during a logging-while-drilling (LWD) operation, a downhole imaging device into the borehole,
wherein the initial radial geometry measurements and the dynamic radial geometry measurements are obtained by
acquiring, using the downhole imaging device during the LWD operation, downhole image logs of the borehole in the static condition and the dynamic condition of the borehole; and
analyzing, using a calibrated image log interpretation algorithm, the downhole image logs to generate the initial radial geometry measurements and the dynamic radial geometry measurements.

5. The method of claim 4, further comprising:
generating a calibrated image log model by comparing the downhole image logs to mechanical caliper measurements of the borehole,
wherein the calibrated image log interpretation algorithm is based on the calibrated image log model.

6. The method of claim 4,
wherein the downhole imaging device comprises an ultrasonic imaging device, and
wherein the downhole image logs comprise ultrasonic images.

7. The method of claim 4,
wherein the downhole imaging device comprises a resistivity imaging device, and wherein the downhole image logs comprise resistivity images.

8. A system for determining rock mechanical properties of a subterranean formation, comprising:
a computer processor; and
memory storing instructions, when executed by the computer processor, comprising functionality for:
obtaining, at a selected depth location of a borehole penetrating the subterranean formation, initial radial geometry measurements of the borehole and initial borehole fluid pressure measurements of a borehole fluid;
perturbing a pressure of the borehole fluid;
obtaining, in response to perturbing the pressure of the borehole fluid and at the selected depth location of the borehole, dynamic radial geometry measurements of the borehole and dynamic borehole fluid pressure measurements of the borehole fluid;
analyzing a difference of the initial radial geometry measurements and the dynamic radial geometry measurements to determine differences in radial and axial components of strain tensor at a surface of the borehole at the selected depth location;
determining the rock mechanical properties at the selected depth location by analyzing the differences in the radial and axial components of the strain tensor; and
facilitating, based at least on the determined rock mechanical properties, a drilling operation of the subterranean formation.

9. The system of claim 8, the instructions, when executed by the computer processor, further comprising functionality for:
stopping, prior to obtaining the initial radial geometry measurements and the initial borehole fluid pressure measurements, wherein the initial radial geometry measurements and the initial borehole fluid pressure measurements are obtained in a static condition of the borehole; and
activating, prior to obtaining the dynamic radial geometry measurements and the dynamic borehole fluid pressure measurements, a rig mud pump to perturb the pressure of the borehole fluid, wherein the dynamic radial geometry measurements and the dynamic borehole fluid pressure measurements are obtained in a dynamic condition of the borehole.

10. The system of claim 8, the instructions, when executed by the computer processor, further comprising functionality for:
deploying a downhole mechanical caliper device into the borehole,
wherein the initial radial geometry measurements and the dynamic radial geometry measurements are obtained using the downhole mechanical caliper device.

11. The system of claim 9, the instructions, when executed by the computer processor, further comprising functionality for:
deploying, during a logging-while-drilling (LWD) operation, a downhole imaging device into the borehole,
wherein the initial radial geometry measurements and the dynamic radial geometry measurements are obtained by
acquiring, using the downhole imaging device during the LWD operation, downhole image logs of the borehole in the static condition and the dynamic condition of the borehole; and
analyzing, using a calibrated image log interpretation algorithm, the downhole image logs to generate the initial radial geometry measurements and the dynamic radial geometry measurements.

12. The system of claim 11, the instructions, when executed by the computer processor, further comprising functionality for:
generating a calibrated image log model by comparing the downhole image logs to mechanical caliper measurements of the borehole,
wherein the calibrated image log interpretation algorithm is based on the calibrated image log model.

13. The system of claim 11,
wherein the downhole imaging device comprises an ultrasonic imaging device, and
wherein the downhole image logs comprise ultrasonic images.

14. The system of claim 11,
wherein the downhole imaging device comprises a resistivity imaging device, and
wherein the downhole image logs comprise resistivity images.

15. A well system for performing a drilling operation of a subterranean formation, comprising:
a bottom hole assembly (BHA) coupled to a drill string that is suspended in a borehole penetrating the subterranean formation; and
a rock property analysis system coupled to the BHA and comprising functionality for:
obtaining, at a selected depth location of the borehole, initial radial geometry measurements of the borehole and initial borehole fluid pressure measurements of a borehole fluid;
perturbing a pressure of the borehole fluid;
obtaining, in response to perturbing the pressure of the borehole fluid and at the selected depth location of the borehole, dynamic radial geometry measurements of the borehole and dynamic borehole fluid pressure measurements of the borehole fluid;
analyzing a difference of the initial radial geometry measurements and the dynamic radial geometry measurements to determine differences in radial and axial components of strain tensor at a surface of the borehole at the selected depth location;
determining rock mechanical properties at the selected depth location by analyzing the differences in the radial and axial components of the strain tensor; and
performing, using the BHA and based at least on the determined rock mechanical properties, a drilling operation of the subterranean formation.

16. The well system of claim 15, the rock property analysis system further comprising functionality for:
stopping, prior to obtaining the initial radial geometry measurements and the initial borehole fluid pressure measurements, wherein the initial radial geometry measurements and the initial borehole fluid pressure measurements are obtained in a static condition of the borehole; and
activating, prior to obtaining the dynamic radial geometry measurements and the dynamic borehole fluid pressure measurements, a rig mud pump to perturb the pressure of the borehole fluid, wherein the dynamic radial geometry measurements and the dynamic borehole fluid pressure measurements are obtained in a dynamic condition of the borehole.

17. The well system of claim 15, the rock property analysis system further comprising functionality for:
deploying a downhole mechanical caliper device into the borehole,
wherein the initial radial geometry measurements and the dynamic radial geometry measurements are obtained using the downhole mechanical caliper device.

18. The well system of claim 16, the rock property analysis system further comprising functionality for:
deploying, during a logging-while-drilling (LWD) operation, a downhole imaging device into the borehole,
wherein the initial radial geometry measurements and the dynamic radial geometry measurements are obtained by
acquiring, using the downhole imaging device during the LWD operation, downhole image logs of the borehole in the static condition and the dynamic condition of the borehole; and
analyzing, using a calibrated image log interpretation algorithm, the downhole image logs to generate the initial radial geometry measurements and the dynamic radial geometry measurements.

19. The well system of claim 18, the rock property analysis system further comprising functionality for:
generating a calibrated image log model by comparing the downhole image logs to mechanical caliper measurements of the borehole,
wherein the calibrated image log interpretation algorithm is based on the calibrated image log model.

20. The well system of claim 19,
wherein the downhole imaging device comprises an ultrasonic imaging device or a resistivity imaging device, and
wherein the downhole image logs comprise ultrasonic images or resistivity images.
